(19) United States
(12) Patent Application Publication
(10) Pub. No.: US 2007/0197767 A1
(43) Pub. Date: Aug. 23, 2007

(54) Method for producing polymers that are predominantly formed from vinvyl formamide

(75) Inventors: Maximilian Angel, Schifferstadt (DE); Lysander Chrisstoffels, Limburgerhof (DE); Claudia Wood, Weinheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/547,799

(22) PCT Filed: Apr. 22, 2005
(86) PCT No.: PCT/EP05/04339

§ 371 Date: Oct. 6, 2006

(30) Foreign Application Priority Data
May 4, 2004 (DE) 10 2004 022 256.8

(51) Int. Cl. C08G 69/08

(52) U.S. Cl. 528/310

(57) ABSTRACT

The invention relates to a process for the preparation of polymers composed predominantly of vinylformamide and having a low residual vinylformamide monomer content by subjecting (a) 49.9-99.9% by weight of N-vinylformamide, (b) 0-50% by weight of one or more monomers capable of free radical polymerization, (c) 0.1-5% by weight of at least one monomer from the group consisting of N-vinylpyrrolidone, N-vinyl-N-methylacetamide, N-vinylcaprolactam and N-vinylpiperidone to free radical polymerization, the monomer (c) being added to the polymerization only when the proportion of still unpolymerized monomer (a) is <5% by weight.

The present invention relates to a process for the preparation of polymers composed predominantly of vinylformamide, and the use of the polymers prepared by this process.

### PRIOR ART

WO 99/25745 describes a process for reducing the N-vinylformamide monomer content in corresponding polymers, a scavenging agent from the group consisting of the oxidizing agents, reducing agents, Grignard reagents, alkali metal cyanides and ammonia derivatives being added to the polymer before the hydrolysis.

EP 870782 A2 describes polymers having a reduced residual monomer content, which are obtained by a certain combination of a wash agent/diluent, such as ethyl acetate and acetone, with an initiator.

EP 1031585 describes copolymers of vinylformamide having a low residual monomer content, obtainable by a process with reduction of pH by 2 to 5 units between the beginning and the end of the polymerization.

WO 2001002450 describes the preparation of a polymer by using vinylformamide as a comonomer. By subsequent treatment of the polymer with hydrogen peroxide, the residual monomer content is reduced.

DE 19836992 describes a process for eliminating formamide from polymers having N-vinylformamide units by treating the polymer with acid or base.

### OBJECT

It was therefore the object to provide a process for the free radical polymerization of polymers composed predominantly of vinylformamide, which gives polymers having a substantially reduced residual vinylformamide monomer content in comparison with the polymers prepared by known processes.

### DESCRIPTION OF THE INVENTION

A process for the preparation of polymers composed predominantly of vinylformamide and having a low residual vinylformamide monomer content by subjecting
(a) 49.9-99.9% by weight of N-vinylformamide,
(b) 0-50% by weight of one or more monomers capable of free radical polymerization,
(c) 0.1-5% by weight of at least one monomer from the group consisting of N-vinylpyrrolidone, N-vinyl-N-methylacetamide, N-vinylcaprolactam and N-vinylpiperidone
   to free radical polymerization, the monomer (c) being added to the polymerization only when the proportion of still unpolymerized monomer (a) is <5% by weight, has been found.

The novel process is suitable for the preparation of polymers of 49.9-99.9% by weight, preferably of 60-98% by weight, particularly preferably of 75-95% by weight, very particularly preferably of from 80 to 90% by weight, of N-vinylformamide. Below, vinylformamide is used synonymously with N-vinylformamide or with the abbreviation VFA, unless expressly noted otherwise.

Suitable monomers (b) are the N-vinylimidazole derivatives of the general formula (I), where R¹ to R³ are hydrogen, C₁-C₄-alkyl or phenyl 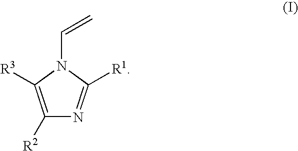
Diallylamines of the general formula (II), where R⁴ is C₁-C₂₄-alkyl, are furthermore suitable 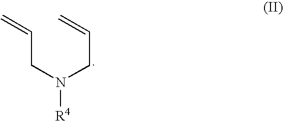
N,N-Dialkylaminoalkyl acrylates and methacrylates and N,N-dialkylaminoalkylacrylamides and -methacrylamides of the general formula (III) 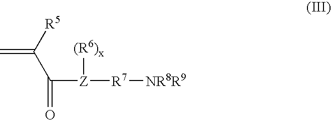
where R⁵ and R⁶, independently of one another, are a hydrogen atom or a methyl radical, R⁷ is an alkylene radical having 1 to 24 carbon atoms, optionally substituted by alkyl radicals, and R⁸ and R⁹ are C₁-C₂₄-alkyl radicals, are furthermore suitable. Z is a nitrogen atom together with x=1 or is an oxygen atom together with x=0.

Examples of compounds of the general formula (I) are shown in table 1 below:

TABLE 1

| R¹ | R² | R³ |
|---|---|---|
| H | H | H |
| Me | H | H |
| H | Me | H |
| H | H | Me |
| Me | Me | H |
| H | Me | Me |
| Me | H | Me |
| Ph | H | H |
| H | Ph | H |
| H | H | Ph |
| Ph | Me | H |
| Ph | H | Me |
| Me | Ph | H |
| H | Ph | Me |
| H | Me | Ph |
| Me | H | Ph |

Me = Methyl
Ph = Phenyl

Further useful monomers of the formula (I) are the ethyl, propyl or butyl analogs of the methyl-substituted 1-vinylimidazoles listed in table 1.

Examples of compounds of the general formula (II) are diallylamines in which R⁴ is methyl, ethyl, isopropyl, n-propyl, isobutyl, n-butyl, tert-butyl, pentyl, hexyl, heptyl, octyl, nonyl or decyl. Examples of longer-chain radicals R⁴ are undecyl, dodecyl, tridecyl, pentadecyl, octadecyl and eicosyl.

Examples of compounds of the general formula (III) are
N,N-dimethylaminomethyl (meth)acrylate,
N,N-diethylaminomethyl (meth)acrylate,
N,N-dimethylaminoethyl (meth)acrylate,
N,N-diethylaminoethyl (meth)acrylate,
N,N-dimethylaminobutyl (meth)acrylate,
N,N-diethylaminobutyl (meth)acrylate,
N,N-dimethylaminohexyl (meth)acrylate,
N,N-dimethylaminooctyl (meth)acrylate,
N,N-dimethylaminododecyl (meth)acrylate,
N-[3-(dimethylamino)propyl]methacrylamide,
N-[3-(dimethylamino)propyl]acrylamide,
N-[3-(dimethylamino)butyl]methacrylamide,
N-[8-(dimethylamino)octyl]methacrylamide,
N-[12-(dimethylamino)dodecyl]methacrylamide,
N-[3-(diethylamino)propyl]methacrylamide,
N-[3-(diethylamino)propyl]acrylamide.

Preferred examples of monomers (b) are 3-methyl-1-vinylimidazolium chloride and methosulfate, dimethyidiallylammonium chloride and N,N-dimethylaminoethyl methacrylate and N-[3-(dimethylamino)propyl]methacrylamide which have been quaternized by methyl chloride, dimethyl sulfate or diethyl sulfate.

The monomers (b) can be used either in quaternized form as monomers or can be polymerized in unquaternized form, the polymer obtained being either quaternized or protonated in the latter case.

For the quaternization of the compounds of the general formulae (I) to (III), for example, alkyl halides having 1 to 24 carbon atoms in the alkyl group, e.g. methyl chloride, methyl bromide, methyl iodide, ethyl chloride, ethyl bromide, propyl chloride, hexyl chloride, dodecyl chloride, lauryl chloride and benzyl halides, in particular benzyl chloride and benzyl bromide, are suitable. Further suitable quaternizing agents are dialkyl sulfates, in particular dimethyl sulfate or diethyl sulfate. The quaternization of the basic monomers of the general formulae (I) to (III) can also be carried out using alkylene oxides, such as ethylene oxide or propylene oxide, in the presence of acids.

The quaternization of the monomer or of a polymer with one of said quaternizing agents can be effected by generally known methods.

Preferred quaternizing agents are: methyl chloride, dimethyl sulfate or diethyl sulfate.

The quaternization of the polymer can be effected completely or only partly. The proportion of quaternized monomers (a) in the polymer may vary over a wide range and is, for example, from about 20 to 100 mol %.

For the protonation, for example, mineral acids, such as HCl, H₂SO₄ and H₃PO₄, and monocarboxylic acids, such as, for example, formic acid and acetic acid, dicarboxylic acids and polyfunctional carboxylic acids, such as, for example, oxalic acid and citric acid, and all other proton-donating compounds and substances which are capable of protonating the corresponding vinylimidazole or diallylamine are suitable. Water-soluble acids are particularly suitable for the protonation.

Protonation is to be understood as meaning that at least some of the protonatable groups of the polymer, preferably from 20 to 100 mol %, will be protonated, resulting in a total cationic charge of the polymer.

Suitable monomers (b) are C₁-C₄₀-alkyl esters of (meth)acrylic acid, the esters being derived from linear, branched or carbocyclic alcohols, e.g. methyl (meth)acrylate, ethyl (meth)acrylate, tert-butyl (meth)acrylate, isobutyl (meth)acrylate, n-butyl (meth)acrylate or stearyl (meth)acrylate, or esters of alkoxylated fatty alcohols, for example C₁-C₄₀-fatty alcohols, reacted with ethylene oxide, propylene oxide or butylene oxide, in particular C₁₀-C₁₈-fatty alcohols, reacted with from 3 to 150 ethylene oxide units. N-Alkyl-substituted acrylamides having linear, branched or carbocyclic alkyl radicals, such as N-tert-butylacrylamide, N-butylacrylamide, N-octylacrylamide or N-tert-octylacrylamide, are furthermore suitable.

Styrene, vinyl and allyl esters of C₁-C₄₀-carboxylic acids, which may be linear, branched or carbocyclic, e.g. vinyl acetate, vinyl propionate, vinyl neononanoate or vinyl neoundecanoic acid, vinyl tert-butylbenzoate, alkyl vinyl ethers, for example methyl vinyl ether, ethyl vinyl ether, butyl vinyl ether or stearyl vinyl ether, are furthermore suitable.

Acrylamides, such as N-tert-butylacrylamide, N-butylacrylamide, N-octylacrylamide, N-tert-octylacrylamide and N-alkyl-substituted acrylamides having linear, branched or carbocyclic alkyl radicals, where the alkyl radical may have the meanings stated above for R⁴.

Particularly suitable monomers (b) are C₁- to C₂₄-alkyl esters, very particularly C₁- to C₁₀-alkyl esters, of (meth)acrylic acid, e.g. methyl (meth)acrylate, ethyl (meth)acrylate, tert-butyl (meth)acrylate, isobutyl (meth)acrylate or n-butyl (meth)acrylate, and acrylamides, such as N-tert-butylacrylamide or N-tert-octylacrylamide.

Particularly suitable monomers (b) are acrylamide, methacrylamide, N,N-dimethylacrylamide, N-methylolmethacrylamide, N-vinyloxazolidone, N-vinyltriazole, hydroxyalkyl (meth)acrylates, e.g. hydroxyethyl (meth)acrylate and hydroxypropyl (meth)acrylates or alkylethylene glycol (meth)acrylates having 1 to 50 ethylene glycol units in the molecule.

N-Vinylimidazoles of the general formula (I), where R¹ to R³ are hydrogen, C₁-C₄-alkyl or phenyl, diallylamines of the general formula (II), and dialkylaminoalkyl (meth)acrylates and dialkylaminoalkyl (meth)acrylamides of the general formula (III), e.g. dimethylaminoethyl methacrylate or dimethylaminopropylmethacrylamide, are also suitable.

Unsaturated carboxylic acids and unsaturated anhydrides, e.g. acrylic acid, methacrylic acid, crotonic acid, itaconic acid, maleic acid, fumaric acid or their corresponding anhydrides and unsaturated sulfonic acids, such as, for example, acrylamidopropane-sulfonic acid, and the salts of the unsaturated acids, such as, for example, the alkali metal or ammonium salts, are furthermore suitable.

The monomer (b) is used in an amount of, optionally, up to 50% by weight, preferably up to 30% by weight, particularly preferably up to 25% by weight, in the novel process.

However, the process is also particularly suitable for the preparation of polymers which, apart from vinylformamide and monomer (c), carry no further polymerized monomer units.

0.1-5% by weight, preferably 0.3-4% by weight, particularly preferably 1-3% by weight, of one or more monomers from the group consisting of N-vinylpyrrolidone, N-vinyl-N-methylacetamide, N-vinylacetamide, N-vinylcaprolactam and N-vinylpiperidone are suitable as monomers (c) for the novel process.

N-Vinylpyrrolidone is particularly suitable as monomer (c).

The preparation of the polymer can be effected by the free radical polymerization processes known per se, for example by solution polymerization, emulsion polymerization, suspension polymerization, precipitation polymerization, inverse suspension polymerization or inverse emulsion polymerization, without the useful methods being limited thereto.

A preferred polymerization method for the novel process is solution polymerization or water-in-water polymerization (W/W polymerization).

The novel process is advantageously carried out by polymerizing the monomers (a) and, if desired, (b) together with a free radical initiator, for example by a batch or feed process. Toward the end of the polymerization, i.e. at a time when less than 5% by weight, preferably less than 3% by weight, particularly preferably less than 1% by weight, of the monomer (a) are still present in the polymerization reaction, the monomer (c) or monomers (c) is or are added. The stated % by weight is based on the total weight of the polymer.

If a plurality of monomers (c) are to be added, they may be added individually or as a premix to the polymerization reaction.

In a preferred embodiment of the present invention, no further starting materials are added to the reaction batch. However, the present invention also includes processes in which further starting materials, such as, for example, regulators, emulsifiers, protective colloids and/or salts, are added to the reaction batch. Initiators which may be used for the free radical polymerization are the water-soluble and water-insoluble peroxo and/or azo compounds customary for this purpose, for example alkali metal or ammonium peroxodisulfates, dibenzoyl peroxide, tert-butyl perpivalate, tert-butyl per-2-ethylhexanoate, di-tert-butyl peroxide, tert-butyl hydroperoxide, azobisisobutyronitrile, azobis(2-amidinopropane) dihydrochloride or 2,2′-azobis(2-methylbutyronitrile). Initiator mixtures or redox initiator systems, such as, for example, ascorbic acid/iron(II) sulfate/sodium peroxodisulfate, tert-butyl hydroperoxide/sodium disulfite, tert-butyl hydroperoxide/sodium hydroxymethanesulfinate, are also suitable. The initiators can be used in the conventional amounts, for example from 0.05 to 5% by weight, based on the amount of the monomers to be polymerized.

The molecular weight and the K value of the polymers can be varied within a wide range in a manner known per se by the choice of the polymerization conditions, for example duration of polymerization, polymerization temperature or initiator concentration, and by the content of crosslinking agent and regulator.

The polymerization can be effected in the presence of a regulator (e). Compounds having a high transfer constant are referred to as regulators (polymerization regulators). Regulators accelerate chain transfer reactions and thus result in a reduction in the degree of polymerization of the resulting polymer without influencing the overall reaction rate.

In the case of the regulators, it is possible to distinguish between mono-, bi- and polyfunctional regulators, depending on the number of functional groups in the molecule which can lead to one or more chain transfer reactions. Suitable regulators are described in detail, for example, by K. C. Berger and G. Brandrup in J. Brandrup, E. H. Immergut, Polymer Handbook, 3rd Edition, John Wiley & Sons, New York, 1989, pages II/81- II/141.

Suitable regulators are, for example, aldehydes, such as formaldehyde, acetaldehyde, propionaldehyde, n-butyraldehyde and isobutyraldehyde.

The following can also be used as regulators: formic acid, its salts or esters, 2,5-diphenyl-1-hexene, ammonium formate, hydroxylammonium sulfate and hydroxylammonium phosphate.

Further suitable regulators are halogen compounds, such as alkyl halides, such as tetrachloromethane, chloroform, bromotrichloromethane, bromoform, allyl bromide and benzyl compounds, such as benzyl chloride and benzyl bromide.

Further suitable regulators are allyl compounds, such as, for example, allyl alcohol, functional allyl ethers, such as allyl ethoxylates, alkyl allyl ethers or glyceryl monoallyl ether.

Preferably used regulators are compounds which contain sulfur in bound form.

Compounds of this type are, for example, inorganic hydrogen sulfites, disulfites and dithionites or organic sulfides, disulfides, polysulfides, sulfoxides or sulfones. The following regulators may be mentioned by way of example: di-n-butyl sulfide, di-n-octyl sulfide, diphenyl sulfide, thiodiglycol, ethylthioethanol, diisopropyl disulfide, di-n-butyl disulfide, di-n-hexyl disulfide, diacetyl disulfide, diethanol sulfide, di-tert-butyl trisulfide, dimethyl sulfoxide, dialkyl sulfide, dialkyl disulfide and/or diaryl sulfide.

Organic compounds which contain sulfur in bound form are particularly preferred.

Compounds preferably used as polymerization regulators are thiols (compounds which contain sulfur in the form of SH groups, also referred to as mercaptans). Mono-, bi- and polyfunctional mercaptans, mercaptoalcohols and/or mercaptocarboxylic acids are preferred as regulators.

Examples of these compounds are allyl thioglycolates, ethyl thioglycolate, cysteine, 2-mercaptoethanol, 1,3-mercaptopropanol, 3-mercaptopropane-1,2-diol, 1,4-mercaptobutanol, mercaptoacetic acid, 3-mercaptopropionic acid, mercaptosuccinic acid, thioglycerol, thioacetic acid, thiourea and alkyl mercaptans, such as n-butyl mercaptan, n-hexyl mercaptan or n-dodecyl mercaptan.

Particularly preferred thiols are cysteine, 2-mercaptoethanol, 1,3-mercaptopropanol, 3-mercaptopropane-1,2-diol, thioglycerol and thiourea.

Examples of bifunctional regulators which contain two sulfurs in bound form are bifunctional thiols, such as, for example, dimercaptopropanesulfonic acid (sodium salt), dimercaptosuccinic acid, dimercapto-1-propanol, dimercaptoethane, dimercaptopropane, dimercaptobutane, dimercaptopentane, dimercaptohexane, ethylene glycol bisthioglycolates and butanediol bisthioglycolate.

Examples of polyfunctional regulators are compounds which contain more than two sulfurs in bound form. Examples of these are trifunctional and/or tetrafunctional mercaptans.

Preferred trifunctional regulators are trifunctional mercaptans, such as, for example trimethylolpropane tris(2-mercaptoethanoate), trimethylolpropane tris(3-mercaptopropionate), trimethylolpropane tris(4-mercaptobutanoate), trimethylolpropane tris(5-mercaptopentanoate), trimethylolpropane tris(6-mercaptohexanoate) and trimethylolpropane tris(2-mercaptoacetate).

Glyceryl thioglycolate, glyceryl thiopropionate, glyceryl thioethylate, glyceryl thiobutanoate.

1,1,1-Propanetriyl tris-(mercaptoacetate), 1,1,1-propanetriyl tris-(mercaptoethanoate), 1,1,1-propanetriyl tris-(mercaptoproprionate), 1,1,1-propanetriyl tris-(mercaptobutanoate), 2-hydroxmethyl-2-methyl-1,3-propanediol tris-(mercaptoacetate), 2-hydroxmethyl-2-methyl-1,3-propanediol tris-(mercaptoethanoate), 2-hydroxmethyl-2-methyl-1,3-propanediol tris-(mercaptopropionate), 2-hydroxmethyl-2-methyl-1,3-propanediol tris-(mercaptobutanoate).

Particularly preferred trifunctional regulators are glyceryl thioglycolate, trimethylolpropane tris(2-mercaptoacetate) and 2-hydroxmethyl-2-methyl-1,3-propanediol tris-(mercaptoacetate).

Preferred tetrafunctional mercaptans are pentaerythritol tetrakis(2-mercaptoacetate), pentaerythritol tetrakis(2-mercaptoethanoate), pentaerythritol tetrakis(3-mercaptopropionate), pentaerythritol tetrakis(4-mercaptobutanoate), pentaerythritol tetrakis(5-mercaptopentanoate) and pentaerythritol tetrakis(6-mercaptohexanoate).

Further suitable polyfunctional regulators are Si compounds which are formed by reaction of compounds of the formula (IVa). Si compounds of the formula (IVb) are furthermore suitable as polyfunctional regulators. 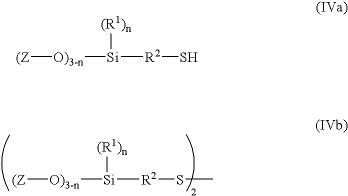
where
n is a value from 0 to 2,
R¹ is a C₁-C₁₆-alkyl group or phenyl group,
R² is a C₁-C₁₈-alkyl group or the cyclohexyl or phenyl group,
Z is a C₁-C₁₈-alkyl group, C₂-C₁₈-alkylene group or C₂-C₁₈-alkynyl group whose carbon atoms may be replaced by nonneighboring oxygen or halogen atoms, or is one of the groups 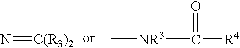
   where
R₃ is a C₁-C₁₂-alkyl group and
R₄ is a C₁-C₁₈-alkyl group.

All regulators mentioned may be used individually or in combination with one another.

Crosslinking agents, i.e. compounds having at least 2 ethylenically unsaturated, nonconjugated double bonds in the molecule, may furthermore be added to the reaction batch.

Suitable crosslinking agents are, for example, acrylates, methacrylates, allyl ethers or vinyl ethers of at least dihydric alcohols. Some or all of the OH groups of the parent alcohol may have been etherified or esterified; however, the crosslinking agents contain at least two ethylenically unsaturated groups.

Examples of the parent alcohols are dihydric alcohols, such as 1,2-ethanediol, 1,2-propanediol, 1,3-propanediol, 1,2-butanediol, 1,3-butanediol, 2,3-butanediol, 1,4-butanediol, but-2-ene-1,4-diol, 1,2-pentanediol, 1,5-pentanediol, 1,2-hexanediol, 1,6-hexanediol, 1,10-decanediol, 1,2-dodecanediol, 1,12-dodecanediol, neopentylglycol, 3-methylpentane-1,5-diol, 2,5-dimethyl- 1,3-hexanediol, 2,2,4-trimethyl-1 ,3-pentanediol, 1,2-cyclohexanediol, 1,4-cyclohexanediol, 1,4-bis(hydroxymethyl)cyclohexane, mononeopentylglycol hydroxypivalate, 2,2-bis(4-hydroxyphenyl)propane, 2,2-bis[4-(2-hydroxypropyl)phenyl]propane, diethylene glycol, triethylene glycol, tetraethylene glycol, dipropylene glycol, tripropylene glycol, tetrapropylene glycol, 3-thiopentane-1,5-diol and the polyethylene glycols, polypropylene glycols and polytetrahydrofurans having molecular weights of in each case 200 to 10 000. In addition to the homopolymers of ethylene oxide or of propylene oxide, block copolymers of ethylene oxide or propylene oxide or copolymers which contain incorporated ethylene oxide and propylene oxide groups may also be used. Examples of parent alcohols having more than two OH groups are trimethylolpropane, glycerol, pentaerythritol, 1,2,5-pentanetriol, 1,2,6-hexanetriol, triethoxycyanuric acid, sorbitan and sugars, such as sucrose, glucose and mannose. Of course, the polyhydric alcohols can also be used after reaction with ethylene oxide or propylene oxide as the corresponding ethoxylates or propoxylates. The polyhydric alcohols can also first be converted into the corresponding glycidyl ethers by reaction with epichlorohydrin.

Further suitable crosslinking agents are the vinyl esters or the esters of monohydric, unsaturated alcohols with ethylenically unsaturated C₃- to C₆-carboxylic acids, for example acrylic acid, methacrylic acid, itaconic acid, maleic acid or fumaric acid. Examples of such alcohols are allyl alcohol, 1-buten-3-ol, 5-hexen-1-ol, 1-octen-3-ol, 9-decen-1-ol, dicyclopentenyl alcohol, 10-undecen-1-ol, cinnamyl alcohol, citronellol, crotoyl alcohol or cis-9-octadecen-1-ol. However, the monohydric, unsaturated alcohols can also be esterified with polybasic carboxylic acids, for example malonic acid, tartaric acid, trimellitic acid, phthalic acid, terephthalic acid, citric acid or succinic acid.

Further suitable crosslinking agents are esters of unsaturated carboxylic acids with the polyhydric alcohols described above, for example of oleic acid, crotonic acid, cinnamic acid or 10-undecenoic acid.

Straight-chain or branched, linear or cyclic, aliphatic or aromatic hydrocarbons which have at least two double bonds, which may not be conjugated in the case of aliphatic hydrocarbons, e.g. divinylbenzene, divinyltoluene, 1,7-octadiene, 1-9-decadiene, 4-vinyl-1-cyclohexene, trivinylcyclohexane or polybutadienes having molecular weights of from 200 to 20 000, are also suitable as crosslinking agents.

The acrylamides, methacrylamides and N-allylamines of at least difunctional amines are furthermore suitable as crosslinking agents. Such amines are, for example, 1,2-diaminomethane, 1,2-diaminoethane, 1,3-diaminopropane, 1,4-diaminobutane, 1,6-diaminohexane, 1,12-dodecanediamine, piperazine, diethylenetriamine or isophoronediamine. The amides of allylamine and unsaturated carboxylic acids, such as acrylic acid, methacrylic acid, itaconic acid or maleic acid or at least dibasic carboxylic acids, as described above, are likewise suitable.

Triallylamine and triallylmonoalkylammonium salts, e.g. triallylmethylammonium chloride or methylsulfate, are furthermore suitable as crosslinking agents.

N-Vinyl compounds of urea derivatives, at least difunctional amides, cyanurates or urethanes, for example of urea, ethyleneurea, propyleneurea or tartaramide, e.g. N,N′-divinylethyleneurea or N,N′-divinylpropyleneurea, are also suitable.

Further suitable crosslinking agents are divinyldioxane, tetraallylsilane or tetravinylsilane.

Of course, mixtures of the abovementioned compounds may also be used. Those crosslinking agents which are soluble in the monomer mixture are preferably used.

A detailed description of suitable protective colloids is to be found in Houben-Weyl, Methoden der organischen Chemie, Volume XIV/1, Makromolekulare Stoffe, Georg-Thieme-Verlag, Stuttgart, 1961, pages 411 to 420.

Suitable emulsifiers are anionic, cationic and nonionic emulsifiers. Preferably used accompanying surface-active substances are exclusively emulsifiers whose molecular weights, in contrast to the protective colloids, are usually below 2000 g/mol. Where mixtures of surface-active substances are used, the individual components must of course be compatible with one another, which, in the case of doubt, can be checked by means of a few preliminary experiments. Anionic and nonionic emulsifiers are preferably used as surface-active substances. Customary accompanying emulsifiers are, for example, ethoxylated fatty alcohols (EO degree: 3 to 50, alkyl radical: C₈- to C₃₆), ethoxylated mono-, di- and trialkylphenols (EO degree: 3 to 50, alkyl radical: C₄-to C₉), alkali metal salts of dialkyl esters of sulfosuccinic acid and alkali metal and ammonium salts of alkylsulfates (alkyl radical: C₈- to C₁₂), of ethoxylated alkanols (EO degree: 4 to 30, alkyl radical: C₁₂- to C₁₈), of ethoxylated alkylphenols (EO degree: 3 to 50, alkyl radical: C₄- to C₉), of alkylsulfonic acids (alkyl radical: C₁₂- to C₁₈) and of alkylarylsulfonic acids (alky radical: C₉- to C₁₈).

Suitable emulsifiers also appear in Houben-Weyl, Methoden der organischen Chemie, Volume 14/1, Makromolekulare Stoffe, Georg Thieme Verlag, Stuttgart, 1961, pages 192 to 208.

Trade names of emulsifiers are, for example, Dowfax® 2 A1, Emulan® NP 50, Dextrol® OC 50, emulsifier 825, emulsifier 825 S, Emulan® OG, Texapon® NSO, Nekanil® 904 S, Lumiten® I-RA, Lumiten E 3065 etc.

The surface-active substance is usually used in amounts of from 0.1 to 10% by weight, based on all monomers to be polymerized.

In a preferred embodiment of the novel process, polymerization is followed by an acidic hydrolysis step. For this purpose, the polymer is brought to a pH of from 4 to 6, preferably from 4.5 to 5.5, by means of suitable acids.

Suitable acids for the acidic hydrolysis step are inorganic acids, such as sulfuric acid or hydrochloric acid, and organic acids, such as formic acid, lactic acid or acetic acid.

The acidic hydrolysis is preferably carried out at temperatures in the range from 40 to 150° C., preferably from 50 to 120° C., particularly preferably from 60 to 90° C. Depending on the temperature, a period of from 1 hour to 24 hours is required for the acidic hydrolysis.

The polymer can then be neutralized and isolated.

The polymers composed predominantly of vinylformamide can also be converted into the polymers carrying corresponding amine units by a subsequent alkaline hydrolysis (amide cleavage). Particularly if cationic or cationizable polymers are desired for certain applications, such a complete or partial hydrolysis step in which some or all of the formamide units are hydrolyzed to the amine is advisable.

Alkali metal hydroxides, in particular sodium hydroxide solution and potassium hydroxide solution are suitable for such an alkaline hydrolysis step.

The polymers prepared by the novel process can advantageously be used in the area of cosmetics, in particular of hair cosmetics, and also for the production of cellulose-containing products, in particular paper and cardboard.

### EXAMPLE

Preparation of the Novel Polymer A (W/W Polymerization):

VFA/DADMAC/VP 80 parts/20 parts/2.25 parts

Abbreviations Used

NaOH Sodium hydroxide
Pluriol E 1500 Polyethylene glycol having an average molecular weight of 1500 g/mol (from BASF)
Kollidon 90 F Polyvinylpyrrolidone having a K value of 90 (from BASF)
Kollidon 17 PF Polyvinylpyrrolidone having a K value of 17 (from BASF)
DADMAC N,N-Diallyidimethylammonium chloride
Wako V-50 2,2′-Azobis(2-amidinopropane) dihydrochloride (from Wako)
VP Vinylpyrrolidone

Initially taken mixture:

| | | | Conc. |
|---|---|---|---|
| | 517.72 g | of demineralized water | 100.00% |
| | 2.00 g | of sodium dihydrogenphosphate•H₂O | 100.00% |
| | 0.48 g | of NaOH (10% strength in water) | 10.00% |
| | 179.90 g | of Pluriol E 1500 | 100.00% |
| | 6.00 g | of Kollidon 90 F | 100.00% |
| | 6.00 g | of Kollidon 17 PF | 100.00% |
| Charge 01 | 66.70 g | of DADMAC (60% strength in water) | 60.00% |
| | 160.00 g | of vinylformamide | 100.00% |
| Feed 01 | 3.40 g | of Wako V-50 | 100.00% |
| | 30.60 g | of demineralized water | 100.00% |
| Feed 02 | 4.50 g | of vinylpyrrolidone | 100.00% |
| | 22.20 g | of demineralized water | 100.00% |

| Apparatus: | 2 I HWS pot | |
|---|---|---|
| Procedure: | The starting materials of the initially taken mixture are | |
| | introduced into the apparatus and blanketed with nitrogen | |
| | overnight. | |
| | Charge 1 is then added to the initially taken mixture via a | |
| | funnel and homogenized. | |
| | The pH is checked and, if appropriate, brought to pH 6.8 by | |
| | means of 25% strength sodium hydroxide solution. | |
| | At a stirrer speed (anchor stirrer) of 180 rpm, the apparatus is | |
| | heated to 55° C. | |
| | At 53° C., a portion of feed 1 (5.0 g) is added and | |
| | prepolymerization is effected for 10 minutes. | |
| | Thereafter, 19 g of feed 1 are metered in in 2.5 hours and then | |
| | polymerization is continued at 55° C. for 2 hours. Thereafter, | |
| | feed 2 is metered in in 1 hour and polymerization is continued | |
| | at 55° C. for 1 hour. | |
| | Heating to 75° C. is then effected. At 72° C., 10 g of | |
| | feed 1 are metered in in 1 hour. | |
| | After the end of feed 1, polymerization is continued | |
| | for a further 3 hours at 75° C. | |
| | Finally, cooling to room temperature (about 23° C.) is | |
| | effected. | |
| Analysis: | Appearance: slightly yellowish, viscous, emulsion-like | |
| | Solids content | 40% by weight |
| | Vinylformamide | 50 ppm |
| | Vinylpyrrolidone | 10 ppm |

Comparative example B
Preparation of comparative copolymer B:
VFA/DADMAC 80 parts/20 parts

Initially taken mixture:

| | | | Conc. |
|---|---|---|---|
| | 517.72 g | of demineralized water | 100.00% |
| | 2.00 g | of sodium dihydrogenphosphate•H₂O | 100.00% |
| | 0.48 g | of NaOH (10% strength in water) | 10.00% |
| | 179.90 g | of Pluriol E 1500 | 100.00% |
| | 6.00 g | of Kollidon 90 F | 100.00% |
| | 6.00 g | of Kollidon 17 PF | 100.00% |
| Charge 01 | 66.70 g | of DADMAC (60% strength in water) | 60.00% |
| | 160.00 g | of vinylformamide | 100.00% |
| Feed 01 | 3.40 g | of Wako V-50 | 100.00% |
| | 30.60 g | of demineralized water | 100.00% |

| Apparatus: | 2 I HWS pot | |
|---|---|---|
| Procedure: | The starting materials of the initially taken mixture are | |
| | introduced into the apparatus and blanketed with nitrogen | |
| | overnight. | |
| | Charge 1 is then added to the initially taken mixture via a | |
| | funnel and homogenized. | |
| | The pH is checked and, if appropriate, brought to pH 6.8 by | |
| | means of 25% strength sodium hydroxide solution. | |
| | At a stirrer speed (anchor stirrer) of 180 rpm, the apparatus | |
| | is heated to 55° C. | |
| | At 53° C., a portion of feed 1 (5.0 g) is added and | |
| | prepolymerization is effected for 10 minutes. | |
| | Thereafter, 19 g of feed 1 are metered in in 2.5 hours and | |
| | then polymerization is continued at 55° C. for 4 hours. | |
| | Heating to 75° C. is then effected. At 72° C., 10 g of | |
| | feed 1 are metered in in 1 hour. | |
| | After the end of feed 1, polymerization is continued for | |
| | a further 3 hours at 75° C. | |
| | Finally, cooling to room temperature (about 23° C.) | |
| | is effected. | |
| Analysis: | Appearance: slightly yellowish, viscous, emulsion-like | |
| | Solids content: | 40.5% |
| | Vinylformamide | 240 ppm |

Apparatus:
2 l HWS pot

Procedure:
The starting materials of the initially taken mixture are introduced into the apparatus and blanketed with nitrogen overnight.
Charge 1 is then added to the initially taken mixture via a funnel and homogenized.
The pH is checked and, if appropriate, brought to pH 6.8 by means of 25% strength sodium hydroxide solution.
At a stirrer speed (anchor stirrer) of 180 rpm, the apparatus is heated to 55° C.
At 53° C., a portion of feed 1 (5.0 g) is added and prepolymerization is effected for 10 minutes.
Thereafter, 19 g of feed 1 are metered in in 2.5 hours and then polymerization is continued at 55° C. for 4 hours.
Heating to 75° C. is then effected. At 72° C.,10 g of feed 1 are metered in in 1 hour.
After the end of feed 1, polymerization is continued for a further 3 hours at 75° C.
Finally, cooling to room temperature (about 23° C.) is effected.

Analysis:

Appearance: slightly yellowish, viscous, emulsion-like Solids content: 40.5% Vinylformamide 240 ppm

1. A process for the preparation of polymers composed predominantly of vinylformamide and having a low residual vinylformamide monomer content, by subjecting
(a) 49.9-99.9% by weight of N-vinylformamide,
(b) 0-50% by weight of one or more monomers capable of free radical polymerization,
(c) 0.1-5% by weight of at least one monomer from the group consisting of N-vinylpyrrolidone, N-vinyl-N-methylacetamide, N-vinylcaprolactam and N vinylpiperidone,
to free radical polymerization, the monomer (c) being added to the polymerization only when the proportion of still unpolymerized monomer (a) is <5% by weight.

2. The process according to claim 1, wherein the monomer (c) is added to the polymerization only when the proportion of still unpolymerized monomer (a) is <2% by weight.

3. The process according to claim 1, wherein the monomer (c) is added to the polymerization only when the proportion of still unpolymerized monomer (a) is <0.5% by weight.

4. The process according to claim 1, wherein an acidic hydrolysis is effected after polymerization is complete.

5. The process according to claim 4, wherein the acidic hydrolysis is effected at a pH of from 4 to 6.

6. The method of using the polymers prepared by a process according to claim 1 for cosmetics.

7. The method of using the polymers prepared by a process according to claim 1 for the production of cellulose-containing products.
